(19) United States
(12) Patent Application Publication
(10) Pub. No.: US 2026/0209436 A1
(43) Pub. Date: Jul. 23, 2026

(54) METHOD FOR PRODUCING POLYAMIDE POWDER FOR 3D PRINTING

(71) Applicant: ARKEMA FRANCE, Puteaux (FR)

(72) Inventors: Emilie Marie SOARES LATOUR, Serquigny (FR); Arnaud LEMAITRE, Serquigny (FR); Geoffroy CAMMAGE, Serquigny (FR)

(73) Assignee: ARKEMA FRANCE, Puteaux (FR)

(21) Appl. No.: 19/139,042

(22) PCT Filed: Dec. 18, 2023
(86) PCT No.: PCT/FR2023/052039

§ 371 Date: Jun. 13, 2025

(30) Foreign Application Priority Data
Dec. 16, 2022 (FR) FR2213672

(51) Int. Cl. C08G 69/20; B29C 64/153; B29C 64/314; B29K 77/00; B33Y 10/00; B33Y 40/10; C09D 177/02

(52) U.S. Cl. CPC C08G 69/20; B29C 64/153; B29C 64/314; B33Y 40/10; C09D 177/02; B29K 2077/00; B33Y 10/00

(57) ABSTRACT

The invention relates to a process for producing polyamide powder by anionic polymerization in a solvent, comprising the following steps: a) the formation of a reaction medium comprising the introduction of at least one lactam monomer into said solvent, the introduction of at least one catalyst into said solvent and the introduction of at least one activator into said solvent at a given temperature; b) polymerization of the lactam monomer into polyamide in the reaction medium; c) precipitation of the polyamide in powder form in the reaction medium; and d) the heating, after step a), preferably after step c), of the reaction medium to a temperature higher than the temperature at which the at least one activator is introduced and ranging from 140 to 200° C.

The invention also relates to a powder obtained by such a process and uses of such a powder.

### DESCRIPTION

### Field of the Invention

The present invention relates to a process for manufacturing a polyamide powder by anionic polymerization in a solvent medium. The invention also relates to a powder obtained by such a process, and to the use thereof in a process for constructing a three-dimensional article.

### Technical Background

The construction of three-dimensional (3D) articles may be used to produce prototypes or various workpieces, for example in the automotive, nautical, aeronautical, aerospace, medical (notably for the manufacture of prostheses, hearing systems, cell tissues, etc.), textile, clothing, fashion, decoration, electronic housing, telephony, home automation, computer, lighting, sport and industrial tool sectors.

Among the techniques for manufacturing 3D articles, the polyamide powder sintering manufacturing process (also known as powder melt agglomeration) is particularly advantageous. This technology makes it possible to achieve fine and complex geometries, that are impossible to achieve by conventional molding techniques. According to this process, a layer of polyamide powder is, conventionally, selectively and briefly irradiated in a chamber with radiation, generally electromagnetic radiation (for example laser beam, infrared radiation, UV radiation), the result being that the powder particles impacted by the radiation melt. The molten particles coalesce and solidify to result in the formation of a solid mass. This process can produce 3D articles by repeated irradiation of a succession of freshly applied layers of powder.

In the case of selective laser sintering (SLS), the following process is conventionally performed. A thin layer of polyamide powder is deposited on a horizontal plate maintained in a chamber heated to a temperature that is between the crystallization temperature Tc and the melting temperature Tm of the polyamide powder. The laser agglomerates the powder particles at different points in the powder layer according to a geometry corresponding to the article, for example using a computer having in its memory the shape of the article and reproducing this shape in the form of slices. Subsequently, the horizontal plate is lowered by a value corresponding to the thickness of a powder layer (for example, between 0.05 and 2 mm and generally of the order of 0.1 mm), then a new powder layer is deposited and the laser agglomerates powder particles according to a geometry corresponding to this new slice of the object. The procedure is repeated until the entire article has been produced. The whole assembly is then cooled gently and the object solidifies as soon as its temperature drops below the crystallization temperature Tc. The parts which have not been agglomerated have thus remained in the powder state. An object surrounded by powder is obtained inside the chamber. After cooling, the object is separated from the powder, which can be reused for another operation.

Immediately after the action of the laser beam, the temperature of the sample is higher than the crystallization temperature Tc of the powder. But sometimes the addition of a new, cooler layer of powder causes the temperature of the workpiece to drop rapidly, which, when it passes below said temperature Tc, causes deformations (“curling” phenomenon) in the manufactured object. Likewise, when the temperature of the powder in the machine comes too close to the melting temperature (Tm) of the powder, this leads to solidification around the workpieces (“caking” phenomenon), which manifests in the presence of lumps or clumps of powder at certain locations on the surface of the object, instead of having a good definition of the final object. When a caking phenomenon occurs, it is then necessary to undertake cleaning of the workpieces in order to remove the powder which has remained attached to the workpieces, before using them. This cleaning is generally carried out by sandblasting which can lead to the degradation of certain fine and/or fragile elements of the 3D workpieces constructed.

To avoid these phenomena, it is therefore important to have the Tc and the Tm of the powder as far apart as possible. The difference Tm−Tc of the powder determines the working temperature window of the device used to agglomerate the powder particles by radiation-induced melting. In the present text, the expression “working window” denotes the build temperature range applicable to a powder when used in 3D printing according to the definition below. The working window is defined by its upper temperature limit and its lower temperature limit. The upper limit of the working window corresponds to the temperature of the build chamber above which agglomeration or caking takes place. The lower limit of the working window corresponds to the temperature of the build chamber below which distortion or deformation or curling occurs. Having a broad working window allows for greater flexibility in terms of the objects built. In addition, this makes it possible to neutralize the high temperature variations generally observed in 3D printing machines, which are generally of the order of +3° C.

If, in order to widen the working window, it is desirable to have a large Tm−Tc difference (since this includes the working window), other parameters also come into play in the definition of the working window. Thus, an enlargement of the working window does not necessarily result from an increase in the Tm−Tc difference.

The enlargement of the working window of a powder is determined for a certain 3D printing system; however, this enlargement of the working window of a powder will occur on any device, although not necessarily in the same proportions.

Various processes for preparing or treating polyamide powder have been described in order to obtain powders suitable for use in 3D printing.

Document WO 2013/090174 relates to a process for treating a powder of a thermoplastic polymer in which a polymerized and isolated powder is subjected to a heat treatment by heating for one or more hours at a temperature relatively close to its melting temperature as determined before this operation. This heat treatment process aims to change the melting temperature, the recrystallization temperature and/or the melting enthalpy of the polymer.

Document EP 1571173 describes a process for preparing a polyamide 12 powder by anionic polymerization of lauryllactam in a solvent for said lauryllactam, in the presence of an organic or mineral filler and an amide in particular proportions relative to the lauryllactam. In the examples in this document, the polymerization process includes a step in which the polymerization ingredients in the solvent are heated for 2 h at 120° C. after the activator has finished being introduced, in order to complete the polymerization.

Document FR 3095205 relates to a process for preparing a polyamide powder by anionic polymerization in a solvent in order to obtain a powder in which the particles comprise a polyamide core and a polyamide shell, the shell having an inherent viscosity in solution and a melting temperature which are higher than those of the core, respectively. In the examples in this document, the polymerization process comprises a step of heating the polymerization medium at 130° C. for 3 h after after the activator has finished being introduced.

There is a real need to provide a process for preparing polyamide powder for use in 3D printing, in particular by sintering, that makes it possible to obtain an enlarged working window for the build temperature of 3D printing devices, while remaining simple to implement.

### SUMMARY OF THE INVENTION

The invention relates firstly to a process for manufacturing a polyamide powder by anionic polymerization in a solvent, comprising the following steps:
a) forming a reaction medium comprising:
   introducing at least one lactam monomer into said solvent;
   introducing at least one catalyst into said solvent; and
   introducing at least one activator into said solvent at a given temperature;
b) polymerizing the lactam monomer to polyamide in the reaction medium;
c) precipitating the polyamide in powder form in the reaction medium; and
d) heating, after step a), and preferably after step c), the reaction medium to a temperature above the temperature for introducing the at least one activator and that is from 140° C. to 200° C.

Alternatively, the process for manufacturing a polyamide powder by anionic polymerization in a solvent comprises the following steps:
(a) forming a reaction medium comprising:
   introducing at least one lactam monomer into said solvent;
   introducing at least one catalyst into said solvent; and
      introducing at least one activator into said solvent at a given temperature, so as to therein polymerize the lactam monomer to polyamide, which precipitates out in powder form in the reaction medium; and
(b) heating, after step a), the reaction medium to a temperature above the temperature for introducing the at least one activator and that is from 140° C. to 200° C.

In some embodiments, the heating of step d) is carried out for a time greater than or equal to 2 h, preferably greater than or equal to 3 h, more preferably greater than or equal to 5 h, more preferably for a time of from 8 to 15 h, more preferentially from 10 to 12 h.

In some embodiments, step a) further comprises introducing at least one filler into the solvent, the at least one filler preferably being a mineral filler, preferably silica, and/or an organic filler, preferably a polyamide powder.

In some embodiments, step a) further comprises introducing at least one amide into the solvent, the at least one amide preferably being an N,N′-alkylene bisamide, more preferably N,N′-ethylene bis-stearamide and/or N,N′-ethylene bis-oleamide.

In some embodiments, the at least one lactam monomer is chosen from the group consisting of 2-pyrrolidone, caprolactam, 2-azacyclononanone, lauryllactam and mixtures thereof.

In some embodiments, the at least one catalyst is chosen from the group consisting of sodium, potassium, alkali metal hydrides and hydroxides, alkali metal alkoxides, and mixtures thereof, preferably from the group consisting of sodium hydride, potassium hydride, sodium, sodium methoxide, sodium ethoxide and mixtures thereof.

In some embodiments, the at least one activator is chosen from the group consisting of lactam-N-carboxyanilides, (mono)isocyanates, polyisocyanates, carbodiimides, cyanamides, acyllactams and acylcarbamates, triazines, ureas, N-substituted imides, esters, phosphorus trichloride and mixtures thereof.

In some embodiments, the solvent is a paraffinic hydrocarbon cut having a boiling temperature range between 120° C. and 170° C.

In some embodiments, the heating temperature in step d) is from 140° C. to 170° C., preferably from 145° C. to 160° C., and more preferably from 145° C. to 155° C.

In some embodiments, the temperature for introducing the at least one activator is from 50° C. to 150° C., preferably from 60° C. to 135° C.

In some embodiments, the process further comprises a step of introducing into the solvent one or more additives chosen from the group consisting of pigments, dyes, carbon black, carbon nanotubes, antioxidants, UV stabilizers and plasticizers.

The invention also relates to a polyamide powder obtained by a manufacturing process as described above.

The invention also relates to the use of a powder as described above, for the construction of a three-dimensional article, preferably layer-by-layer, more preferentially by sintering, even more preferentially by electromagnetic radiation-mediated sintering.

The invention also relates to the use of a powder as described above, for the manufacture of a composite, a substrate coating, a transfer paper, a liquid or solid ink composition, a liquid or solid paint, a structural adhesive, a cosmetic composition or a pharmaceutical composition.

The invention also relates to a process for manufacturing a three-dimensional article, comprising the following steps:
manufacturing a powder by a process as described above;
depositing said powder, preferably in the form of a layer; and
sintering the powder, preferably by means of electromagnetic radiation.

The present invention makes it possible to meet the need expressed above. More particularly, it provides a process for manufacturing a polyamide powder having a wider working temperature window in 3D printing. Thus, when used in 3D printing, this makes it possible to obtain better quality workpieces that have better definition and/or to facilitate, limit or even avoid mechanical cleaning that can damage the manufactured workpieces, in particular those that are thin. Consequently, the powders prepared according to the invention allow the manufacture, by 3D printing, of a broader spectrum of workpiece geometry.

This is accomplished by carrying out a step of “curing” the anionic polymerization reaction medium comprising the heating of said reaction medium, after the reactants and other compounds involved in the polymerization have been introduced, at a certain temperature. Without wishing to be tied to a theory, the inventors consider that the curing step leads to a physical and chemical modification of the surface of the powder particles, for example a crystalline improvement at the surface, which allows the widening of the working window.

The heat treatment described in document WO 2013/090174 is an additional step, which takes place after the synthesis of the powder particles, on a powder which has already been polymerized and isolated from its synthesis medium. On the other hand, the curing step according to the present invention, carried out on the reaction medium, in particular on conclusion of most of the polymerization, forms an integral part of the anionic polymerization phase in a solvent medium, and it allows the crystalline improvement of the precipitated powder particles.

### BRIEF DESCRIPTION OF THE FIGURES

FIG. 1 is a photograph showing an illustrative example of a type 1B tensile dumbbell (length 15 cm and thickness 4 mm) undergoing the curling measurement test as described in the “Examples” section below.

FIG. 2 is a photograph showing the measurement of the curling of the same illustrative dumbbell during the curling measurement test as described in the “Examples” section below. In this illustrative example, the dumbbell has curled 5 mm between these two ends.

FIG. 3 is a photograph showing four examples of workpieces having 10 holes of different sizes manufactured by selective laser sintering with polyamide powders as described in the “Examples” section below. These workpieces illustrate various sensitivities to caking and the scores that can be assigned to evaluate said sensitivities based on the number of holes unblocked, as described in the “Examples” section below. Workpiece A has a score of 0/10, workpiece B has a score of 6/10, workpiece C has a score of 8/10 and workpiece D has a score of 10/10.

### DETAILED DESCRIPTION

The invention will now be described in greater detail and non-limitingly in the description that follows.

Unless otherwise indicated, all the percentages concerning amounts are mass percentages.

In the present text, the amounts indicated for a given species may apply to that species according to all its definitions (as mentioned in the present text), including the more restricted definitions.

### Manufacture of the Powder

The invention firstly relates to a process for manufacturing a polyamide powder by anionic polymerization in a solvent medium. Unless otherwise indicated, the steps of the process, and in particular steps a), b) and c) as defined above, can take place at least partly at the same time. In particular, the polymerization generally begins as soon as all the reactants have been introduced into the reaction mixture and therefore as soon as step a) has ended.

The anionic polymerization takes place by lactam ring opening. It generally comprises three steps: an initiation step to form the lactamate anion, then an activation reaction which leads to the formation of an acyllactam and finally the propagation (or polymerization) step.

The term “polyamide powder” is understood to mean a powder comprising at least particles comprising at least one polyamide, this term including homopolyamides and copolyamides derived from the polymerization of several different comonomers; for the purpose of the present invention, the “polyamide powder” may thus comprise components other than polyamide (in the particles comprising the polyamide or in particles devoid of polyamide).

The anionic polymerization can be carried out continuously or in batch mode. Preferably, it is carried out in batch mode.

In the process according to the invention, at least one lactam monomer, at least one catalyst and at least one activator, and preferably at least one amide, and preferably at least one filler, are brought into contact in a solvent. In the present text, the solvent comprising at least one of the various compounds involved in the polymerization is called the “reaction medium”. The compounds mentioned above may be introduced all at the same time, all in succession or partly at the same time and partly in succession.

Preferably, the solvent is introduced into any suitable device, for example a reactor, then the lactam monomer(s), the amide(s) (when present), the filler(s) (when present), the catalyst(s) and the activator(s), at the same time or in succession. Advantageously, the solvent, the lactam monomer(s), the amide(s) (when present) and the filler(s) (when present) are first introduced into the polymerization device, then the water present in the reaction medium is removed, for example using azeotropic distillation, before the catalyst(s) are added to the anhydrous medium. Preferably, the activator(s) are not added all at once to the reaction medium. This makes it possible to prevent solidification or loss of control of the polymerization. Thus, the activator(s) are preferably added incrementally, or injected continuously over a certain period, at one or more rates of introduction. Preferably, the activator(s) are introduced into the reaction medium after the introduction of the lactam monomers, amides (when present), fillers (when present) and catalyst(s).

Preferably, the solvent used dissolves (at least partially) the lactam monomer(s) and the amide(s). However, the solvent does not dissolve the polyamide that is formed during the polymerization (i.e. the polyamide is insoluble in said solvent under the polymerization conditions). Thus, the polymerization of the polyamide results in it precipitating directly in the form of particles (and therefore powder) in the solvent.

The solvent can be supersaturated with lactam monomer at the activator introduction temperature. Various means make it possible for the solvent to be supersaturated with monomer. One of these means may comprise the steps consisting in saturating the solvent with monomer at a temperature above the temperature for introducing the activator, and then lowering the temperature down to the latter.

Alternatively, the polymerization can be carried out in a solvent which is not supersaturated with lactam monomer. In this case, the reaction medium preferably contains the monomer(s) dissolved in the solvent at a concentration which is far from saturation at the activator introduction temperature.

It is possible to use any solvent for the lactam monomers which is inert with respect to the polymerization reaction. The solvent is preferably a paraffinic hydrocarbon cut (preferably a mixture of isoparaffin, N-paraffin and cycloparaffin). Advantageously, its boiling range is between 120° C. and 200° C., preferably between 140° C. and 170° C.

The lactam monomers are preferably chosen from the group consisting of lauryllactam (lactam 12), caprolactam (lactam 6), 2-pyrrolidone (lactam 4), 2-azacyclononanone (lactam 8) and mixtures thereof. More preferably, the lactam monomers are lauryllactam and/or caprolactam. Particularly preferably, use may be made of a mixture of lactams comprising mainly lauryllactam and a minor amount of shorter-chain lactam, in particular caprolactam or 2-pyrrolidone (lactam 4). In this case, it is particularly preferred to use these two lactams in a weight ratio of 90 to 99.999:0.001 to 10, preferably 92 to 99.99:0.01 to 8, and in particular from 94 to 99.9:0.1 to 6. This is because it has been observed that a very small amount of caprolactammix it possible to maintain the melting temperature of the majority polymer, but affects its crystallization. Thus, a lowering of the crystallization temperature and/or a delay in crystallization is observed, which in both cases reduces the tendency to curling, and thus allows the working window to be widened.

Very preferably, the amide which can be introduced into the reaction medium comprises, or is, one (or more) N,N′-alkylene bisamide(s). Even more advantageously, the amide is chosen from N,N′-alkylene bisamides of fatty acids, and is more preferentially chosen from the group consisting of N,N′-ethylene bis-stearamide (of formula C₁₇H₃₅—C(═O)—NH—CH₂—CH₂—NH—C(═O)—C₁₇H₃₅ and abbreviated to EBS), N,N′-ethylene bis-oleamide (of formula C₁₇H₃₃—C(═O)—NH—CH₂—CH₂—NH—C(═O)—C₁₇H₃₃ and abbreviated to EBO), N,N′-alkylene bis-palmitamides (in particular N,N′-ethylene bis-palmitamide), N,N′-alkylene bis-gadoleamide (in particular N,N′-ethylene bis-gadoleamide), N,N′-alkylene bis-cetoleamide (in particular N,N′-ethylene bis-cetoleamide), N,N′-alkylene bis-erucamide (in particular N,N′-ethylene bis-erucamide), and mixtures thereof. More preferably, the amide is chosen from EBS, EBO and mixtures thereof. The amide may comprise a primary amide preferably containing from 12 to 22 carbon atoms, preferably in combination with an N,N′-alkylene bisamide as described above. This primary amide is preferably chosen from the group consisting of oleamide, N-stearamide, isostearamide, erucamide and mixtures thereof.

The amide, for example the N,N′-alkylene bisamide(s), may be introduced into the reaction medium in an amount of 0.001 to 4 mol, preferably 0.075 to 2 mol, per 100 mol of lactam monomer; in particular the amount of amide (for example of N,N′-alkylene bisamide) may be from 0.001 to 0.05 mol, or 0.05 to 0.1 mol, or 0.1 to 0.5 mol, or 0.5 to 1 mol, or 1 to 1.5 mol, or 1.5 to 2 mol, or 2 to 3 mol, or 3 to 4 mol, per 100 mol of lactam monomer. The addition of an amide as described above helps to adjust the apparent specific surface area (measurable by the BET method) of the polyamide powder particles. The greater the amount of amide added, the higher the apparent specific surface area.

The filler optionally introduced into the reaction medium is intended to serve as a crystallization seed. It may be mineral or organic, or comprise one (or more) mineral filler(s) and one (or more) organic filler(s). As mineral fillers suitable for the invention, mention may be made of silicas, carbon black and/or talc. Suitable organic fillers which may be mentioned include powders of (thermoplastic or thermosetting) polymers which are insoluble in the synthesis solvent, and more particularly powders of polyamide, in particular powders of PA 4, PA 6, PA 8, PA 11, PA 12, PA 6/12, PA 6.12, PA 6.13, PA 6.10, PA 6.6 and/or PA 10.10. As examples of such polyamide powders, mention may be made of the Orgasol powders from Arkema, the Rilsan® fine powders from Arkema, the Vestosint® powders from Evonik and the MICROPAN® powders from Chemopharma. In some advantageous embodiments, the filler is a mineral filler and is more particularly a silica. In other advantageous embodiments, the filler is an organic filler and is more particularly a polyamide powder such as a PA 12 powder.

Preferably, the filler according to the invention is a filler of finely divided particles, in particular having a volume mean diameter of from 0.01 to 40 μm, preferably from 10 to 30 μm. Such ranges of mean diameter make it possible to obtain powder particles having a volume mean diameter suitable in particular for use in a process for constructing a 3D article. The value of the volume mean diameter of the particles corresponds to the arithmetic mean of the diameters of the particles weighted by the volume of said particles. It can be determined according to the standard ISO 13319:2007, for example by using a Multisizer 3 Coulter Counter particle size analyser from Beckman Coulter. The weight ratio of the filler introduced into the reaction medium relative to the lactame monomers introduced into the reaction medium, expressed in %, may be from 0.001% to 65%, preferably from 0.005% to 45%, more preferentially from 0.01% to 30%, even more preferentially from 0.05% to 20%. In some embodiments, this weight ratio can be from 0.001% to 0.1%, or from 0.01% to 0.05%, or from 0.05% to 0.1%, or from 0.1% to 0.3%, or from 0.3% to 0.5%, or from 0.5% to 1%, or from 1% to 2%, or from 2% to 5%, or from 5% to 10%, or from 10% to 20%, or from 20% to 30%, or from 30% to 45%, or from 45% to 65%. The proportion of filler relative to the amount of lactam monomer and also the mean diameter of the filler have an effect on the mean diameter of the polyamide particles obtained. The lower the proportion of filler relative to the amount of lactam monomer, the higher the volume mean diameter of the powder particles. The greater the volume mean diameter of the filler, the higher the volume mean diameter of the powder particles.

The catalyst can be any catalyst which can be used in a process for anionic polymerization of lactams. More particularly, the catalyst is a strong enough base to lead to the formation of a lactamate after reaction with the lactam. The catalyst may be chosen from alkali metals (notably sodium and potassium), alkali metal hydrides and hydroxides, alkali metal alkoxides, and mixtures thereof. As non-limiting examples of suitable catalysts, mention may be made of sodium hydride, potassium hydride, sodium, sodium methoxide and/or sodium ethoxide. The catalyst according to the invention may be a mixture of several catalysts, in particular as described above. Advantageously, the amount of catalyst is from 0.1 to 5 mol, preferably between 0.3 and 3 mol, per 100 mol of lactam monomer, for example from 0.1 to 0.3 mol, or 0.3 to 0.5 mol, or 0.5 to 0.7 mol, or 0.7 to 1 mol, or 1 to 1.5 mol, or 1.5 to 2 mol, or 2 to 3 mol, or 3 to 5 mol, per 100 mol of lactam monomer.

The role of the activator is to induce the formation of acyllactam and to control the polymerization. The activator is advantageously chosen from lactam-N-carboxyanilides, (mono)isocyanates, polyisocyanates, carbodiimides, cyanamides, acyllactams and acylcarbamates, triazines, ureas, N-substituted imides, esters, phosphorus trichloride, carbon dioxide and mixtures thereof. Preferably, the molar ratio of the catalyst relative to the activator is from 0.2 to 2, preferably from 0.8 to 1.2, for example from 0.2 to 0.5, or from 0.5 to 0.8, or from 0.8 to 0.9, or from 0.9 to 1, or from 1 to 1.1, or from 1.1 to 1.2, or from 1.2 to 1.5, or from 1.5 to 2.

In some embodiments, other additives may be added to the reaction medium, such as pigments, dyes, carbon black, carbon nanotubes, antioxidants, UV stabilizers and/or plasticizers.

The polymerization is preferably carried out at atmospheric pressure or even at a slightly higher pressure (partial pressure of the hot solvent). The reaction can be carried out under an inert gas atmosphere, for example under nitrogen. The polymerization begins as soon as the catalyst and activator are added to the reaction mixture.

Preferably, the temperature applied to the reaction medium during the introduction of the activator (referred to as the “activator introduction temperature”) is between from 50° C. to 150° C., and as more preferentially from 60° C. to 135° C., more preferably from 75° C. to 125° C. It may in particular be from 50° C. to 65° C., or from 65° C. to 75° C., or from 75° C. to 85° C., or from 85° C. to 95° C., or from 95° C. to 105° C., or from 105° C. to 115° C., or from 115° C. to 125° C., or from 125° C. to 135° C., or from 135° C. to 150° C.

The activator introduction temperature can be applied to the reaction medium at any time before the addition of the activator or at the time of the addition of the activator. Advantageously, this temperature is applied to the reaction medium after the addition to the solvent of the lactam monomers, the amide (when present) and the filler (when present), and before the addition of the catalyst and the injection of the activator. Before the activator introduction temperature is applied, the reaction medium may for example be at room temperature (i.e. for example at a temperature of 15° C. to 30° C.).

The activator introduction temperature can be maintained for a certain period of time after the start of the introduction of the activator. Preferably, it is maintained until the end of the introduction of the activator. The activator introduction temperature can be maintained for a time of at least 1 h, preferably from 1 to 12 h, preferably from 3 to 10 h, for example from 1 to 2 h, or from 2 to 3 h, or from 3 to 4 h, or from 4 to 5 h, or from 5 to 6 h, or from 6 to 7 h, or from 7 to 8 h, or from 8 to 9 h, or from 9 to 10 h, or from 10 to 11 h, or from 11 to 12 h. Advantageously, the activator introduction temperature is applied over a period of time equal to or substantially equal to the activator introduction time.

The process according to the invention also comprises a step of heating the reaction medium to a temperature of 140° C. to 200° C., which is carried out once the introductions of the lactam monomer, catalyst and activator into the reaction medium have been completed and most of the polymerization has taken place. This step is also referred to as the “curing step” in the present text. According to the present invention, this curing step is carried out on the reaction medium, that is to say while the ingredients and polymerization products are still in the solvent. The curing step makes it possible to continue the polymerization by chain extension reactions, once the activator has been completely added to the reaction medium.

Preferably, the temperature of this curing step (referred to as the “curing temperature” in the present text) is different from the activator introduction temperature, and more preferably higher than the activator introduction temperature. Preferably, the curing step as defined in the present text is carried out after the lactam monomer, the amide when it is present, the filler when it is present, the catalyst and the activator have been added to (or brought into contact with) the solvent.

The curing step is preferably carried out in the same device (for example, reactor) as the steps described above. The curing step is preferably carried out once all the catalyst and activator have been added, and most of the polymerization has therefore taken place. Advantageously, the reaction medium is heated to the curing temperature, preferably gradually, for example over a period of 15 to 60 min, preferably 20 to 40 min, in particular approximately 30 min.

The curing temperature is from 140° C. to 200° C., preferably from 145° C. to 160° C., more preferentially from 145° C. to 155° C. In particular, the curing temperature may be from 140° C. to 145° C., or from 145° C. to 150° C., or from 150° C. to 155° C., or from 155° C. to 160° C., or from 160° C. to 165° C., or from 165° C. to 170° C., or from 170° C. to 175° C., or from 175° C. to 180° C., or from 180° C. to 185° C., or from 185° C. to 190° C., or from 190° C. to 195° C., or from 195° C. to 200° C.

Advantageously, the curing temperature is at least 20° C., preferably at least 40° C., above the activator introduction temperature. In particular, the activator introduction temperature may be at least 20° C., or at least 30° C., or at least 40° C., or at least 50° C., or at least 60° C., or at least 70° C., or at least 80° C., or at least 90° C., higher.

The duration of the curing step (also referred to as the “curing time” in the present text) is preferably greater than or equal to 2 h, more preferably greater than or equal to 3 h and even more preferably greater than or equal to 5 h. Even more advantageously, it is from 8 to 15 h, more preferably from 10 to 12 h. For example, the curing time can be from 2 to 3 h, or from 3 to 4 h, or from 4 to 5 h, or from 5 to 6 h, or from 6 to 7 h, or from 7 to 8 h, or from 8 to 9 h, or from 9 to 10 h, or from 9 to 10 h, or from 10 to 11 h, or from 11 to 12 h, or from 12 to 13 h, or from 13 to 14 h, or from 14 to 15 h.

After the curing step, the reaction medium can be cooled, preferably to a temperature ranging from room temperature to 110° C., more preferably to a temperature of from 60° C. to 90° C.

The polyamide obtained by polymerization precipitates in the solvent in powder form. Thus, the polyamide powder is dispersed in the solvent (i.e. it is not dissolved in the solvent). The polyamide powder can be separated from the solvent by any solid/liquid separation means known to those skilled in the art, such as by settling, spinning, etc.

The polyamide powder may be subjected to a drying step, in particular a vacuum drying step, to remove the solvent residues, for example in an oven.

The powder obtained by polymerization is preferably a polyamide powder chosen from the group consisting of PA 4, PA 6, PA 12, PA 12/6, PA 12/4, PA 4/6, PA 4/6/12 and mixtures thereof.

The invention also relates to a powder obtained by, or capable of being obtained by, a process as described above.

The polyamide powder preferably has a volume mean diameter of 10 to 100 μm, preferably of 20 to 80 μm, more preferably of 25 to 60 μm, more preferentially of 30 to 50 μm. In some embodiments, the volume mean diameter of the powder is from 10 to 20 μm, or from 20 to 30 μm, or from 30 to 35 μm, or from 35 to 40 μm or from 40 to 45μm, or from 45 to 50 μm, or from 50 to 60 μm, or from 60 to 70 μm, or from 70 to 80 μm, or from 80 to 90 μm, or from 90 to 100 μm. The volume mean diameter of the powder can be determined as described above.

Preferably, the Tm−Tc temperature difference of the powder is at least 20° C., more preferably at least 25° C., more preferably at least 28° C., more preferentially at least 30° C., even more preferentially at least 33° C. The crystallization and melting temperatures can be measured according to the standard ISO 11357-3:2018 Plastics—Differential scanning calorimetry (DSC)—Part 3.

The polyamide can have an inherent viscosity of from 0.8 to 1.7 (g/100 g)⁻¹, preferably from 1.0 to 1.5 (g/100 g)⁻¹. The inherent viscosity is measured, preferably in an Ubbelohde-type viscometer, according to the standard ISO 307:2019, but using m-cresol as solvent and a temperature of 20° C. The inherent viscosity has the dimension of an inverse concentration and is equal to the natural logarithm of the relative viscosity, all divided by the concentration of polymer dissolved in the solvent.

### Use of the Powder

The invention also relates to the use of a polyamide powder as described above for the manufacture (or construction) of a three-dimensional article.

The polyamide powder according to the invention can be used in a 3D printing process. Within the meaning of the invention, the term “3D printing” or “additive manufacturing” is understood to mean any process for manufacturing workpieces in volume by addition or agglomeration of powder, layer by layer. Within the meaning of the invention, the term “3D printing” or “additive manufacturing” is also understood to mean selective sintering technologies using an absorber, in particular the technologies known under the names “High Speed Sintering” (HSS) and “Multi-Jet Fusion” (MJF).

Preferably, the polyamide powder according to the invention is used in a process for manufacturing a three-dimensional article by agglomeration of powder by melting using radiation or a selective sintering process. The term “sintering” in the present text includes all processes of 3D printing by agglomeration of the powder by melting, regardless of the type of radiation.

More particularly, the process for manufacturing a 3D object according to the invention comprises:
a) depositing the powder according to the invention, preferably in the form of a layer; and
b) sintering the powder, preferably by means of a beam of electromagnetic radiation.

Preferably, steps a) and b) are repeated to form the three-dimensional article.

The layer deposited in step a) is preferably heated to a temperature referred to as the build temperature. The term “build temperature” (referred to as the “temperature of the bed of powder”) denotes the temperature at which the bed of powder, of a constituent layer of a three-dimensional article under construction, is heated during the process of layer-by-layer sintering of the powder. This temperature is lower than the melting temperature of the polyamide and higher than the crystallization temperature of the polyamide and, very preferably, it is included within the working window of the polyamide powder.

The process for manufacturing a 3D object according to the invention may comprise a step of manufacturing the powder used in step a) according to a process as described above.

The radiation can be chosen from any radiation well known to those skilled in the art. By way of example of radiation, mention may be made of a laser beam (laser sintering), infrared radiation, UV radiation, or any source of electromagnetic radiation which makes it possible to melt the powder layer by layer in order to manufacture three-dimensional objects.

The device used can be any sintering device well known to those skilled in the art. By way of example, it is possible to mention the sintering devices sold by EOS, 3D Systems, Aspect, Trump Precision Machinery, Hewlett Packard, Sinterit, Sintratec, Sharebot, FormLabs, Sonda Sys, Farsoon, Prodways, Ricoh, Wematter3D, VoxelJet, Xaar, etc. By way of example of sintering devices, it is possible to mention EOSINT P396 and Formiga P100 from EOS GmbH.

According to an advantageous sintering process, a thin layer of powder is deposited on a horizontal plate maintained in a chamber heated to the build temperature. Advantageously, electromagnetic radiation then provides the energy needed to sinter the powder particles at various points of the powder layer in a geometry corresponding to an object (for example using a computer a computer that stores the shape of an object and that reproduces this shape in the form of slices). Next, the horizontal plate is lowered by a value corresponding to the thickness of one powder layer, and a new layer is deposited. The electromagnetic radiation provides the energy needed to sinter the powder particles in a geometry corresponding to this new slice of the object, and so on. The procedure is repeated until the object has been manufactured.

The powder layer deposited on a horizontal plate (before sintering) can have a thickness of from 20 to 200 μm and preferably from 50 to 150 μm. The layer of agglomerated material, after sintering, can have a thickness of from 10 to 150 μm, preferably from 30 to 100 μm.

Preferably, the composition of the invention is used in a selective laser sintering process. The composition can also be used in a sintering process of the MJF and HSS (high speed sintering) type.

Preferably, the three-dimensional object manufactured by a process according to the invention is chosen from a prototype, a workpiece model (“rapid prototyping”), a small-series finished workpiece (“rapid manufacturing”), in particular for motor vehicle, nautical, aeronautical, aerospace, medical (prostheses, hearing systems, and the like), textile, clothing, fashion and decoration fields, the field of housings for electronics, telephony, home automation, computing, lighting, sport, and industrial tools.

The use of the powder according to the invention in additive manufacturing is advantageous because the polyamide powder can be recycled in several successive runs. The polyamide powder can thus be used several times, alone or mixed with other recycled or non-recycled powders. Specifically, the powder which has not been agglomerated can be recovered by screening, the screen retaining the 3D objects and allowing the powder to flow through. Preferably, the powder according to the invention can be recycled at least 3 times, preferably at least 5 times and more preferably at least 10 times.

Preferably, in each build cycle, or “run”, the content of recycled powder is at least 50%, preferably at least 60%, more preferably at least 70%, by weight, relative to the total weight of powder used in the machine on each run. In other words, apart from the first run which uses 100% of fresh powder, each following run reuses at least 50%, preferably at least 60%, preferably at least 70%, by weight of powder from the preceding run which has not been sintered, relative to the total weight of powder used in the machine on each run.

Before being used, the manufactured 3D object can be easily cleaned using any cleaning technique well known to those skilled in the art. For example, the object can be cleaned using a sandblaster.

The invention also relates to the use of a polyamide powder as described above for the manufacture of a composite, a substrate coating, notably a metal substrate coating (coil coating), a transfer paper, a liquid or solid ink composition, a liquid or solid paint, a structural adhesive, a cosmetic composition or a pharmaceutical composition.

### Examples

The following examples illustrate the invention without limiting it.

In the examples below, the working windows of various polyamide powders were evaluated.

The crystallization and melting temperatures and the melting enthalpy of powders were measured according to the standard ISO 11357-3:2018 (DSC), the volume mean diameter of the powders was determined according to the standard ISO 13319:2007 and the inherent viscosity of the powders was determined according to the standard ISO 307:2019 but at a temperature of 20° C. and using m-cresol as solvent.

### Procedure for the Evaluating the Working Window

The working temperature window was determined in a P100 (EOS) laser sintering machine, working at constant energy for the laser and at constant temperature of the removal chamber so as to vary only the temperature of the build chamber. The laser conditions used for this test are the following:
Temperature of the removal chamber: 140° C.
Contour
   Laser power: 16 W
   Speed: 1500 mm/s
Hatching
   Power: 18 W
   Speed: 3000 mm/s
   Beam offset: 0.20 mm
   Energy: 0.3 mJ/mm³

The temperature of the build chamber (T_{bc}) corresponds to the temperature to which the upper layer of the powder bed is heated before the passage of the laser. A model 3D printing construction of different workpieces has been developed, according to which:
1) 40 layers of powder are deposited successively and they are each heated to T_{bc} before the next layer is deposited (for these 40 layers, the laser is not used to selectively melt the powder); then
2) starting from the 41^{st} layer, the 3D construction by selective melting of the powder by the laser starts as soon as the temperature of the powder layer reaches T_{bc}, for each layer, in such a way as to build a defined workpiece; then
3) 40 layers of powder are deposited successively and they are each heated up to T_{bc} before the next layer is deposited (for these 40 layers, the laser is not used to selectively melt the powder).

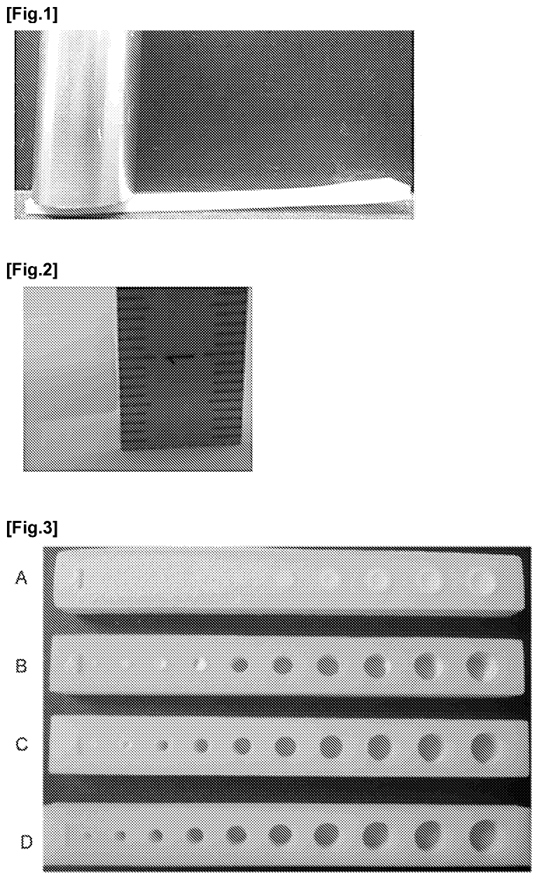

The workpiece defined in step 2) above is either a tensile dumbbell of 1B type according to ISO 527-2 (length 15 cm and thickness 4 mm) as shown in FIG. 1, which is particularly sensitive to curling, or a workpiece with 10 holes of different sizes (thickness 4 mm) as shown in FIG. 2, which are particularly sensitive to caking.

For each of the powders tested, 5 tensile dumbbells of 1B type and 2 workpieces with 10 holes were manufactured according to the above model construction.

A two-step protocol, based on a temperature sweep of the build chamber, was then carried out to determine the limits of the working window of the powders. These two steps are as follows:
1) The model construction described above is first carried out at T_{bc}=168° C. It is then repeated anew several times, each time increasing the temperature of the build chamber by 2° C. by 2° C. until T_{bc}=176° C. is reached. The machine is then cooled and the 3D objects are recovered.
2) The model construction described above is again carried out at T_{bc}=168° C. It is then repeated anew several times, each time decreasing the temperature of the build chamber by 2° C. by 2° C. until T_{bc}=160° C. is reached. The machine is then cooled and the 3D objects are recovered.

For each build chamber temperature (T_{bc}) tested, the following are determined:
the deformation of the dumbbells (reflecting the sensitivity to curling), and
the ease of cleaning the workpieces with 10 holes (representative of sensitivity to caking).

The deformation of the dumbbells was determined by measuring their flatness. The flatter the test specimen (dumbbell), the less marked the deformation, and therefore the manufactured 3D object will correspond to the intended geometry. To determine their flatness, each test specimen was placed on a flat surface, a weight of 1 kg was placed on the left grip section of the dumbbell, and the distance between the end of the right grip section and the flat surface was measured. This measurement was repeated on each of the four longitudinal faces of the dumbbells and the greatest distance measured corresponds to the deformation adopted.

For each build temperature tested, the deformation was measured for each of the 5 workpieces constructed at said build temperature, and the final deformation is the average of the five measurements adopted (this makes it possible to take into account the temperature variations at the surface of the powder bed).

A distance of less than or equal to 2 mm was considered to meet the geometric requirements of the 3D objects and therefore to correspond to a curling phenomenon that is not very marked.

The lower limit of the working window corresponds to the lowest temperature of the build chamber for which a distance less than or equal to 2 mm was obtained as the final deformation.

The ease or difficulty of cleaning workpieces with 10 holes of different sizes was evaluated using a compressed air blower without sandblasting. The greater the number of holes in the workpiece unblocked using the blower, the easier the cleaning. A score out of 10 was awarded according to the number of holes unblocked. For example, a score of 10/10 is awarded to powders for which the 10 holes have been unblocked, and which will therefore be the easiest to clean. Conversely, a score of 0/10 is awarded to powders for which no hole has been unblocked, and therefore which agglomerate strongly and which will be the most difficult to clean (causing a longer cleaning time and possibly leading to degradation of certain fine and/or fragile elements of the 3D workpieces constructed).

For each build temperature tested, a score was awarded to each of the two workpieces constructed at said build temperature, and the final score is the average of the two scores obtained (this makes it possible to take into account the temperature variations at the surface of the powder bed).

A score of greater than or equal to 8/10 was considered to retain a satisfactory ease of cleaning and therefore to correspond to a caking phenomenon that is not very marked.

The upper limit of the working window corresponds to the highest temperature of the build chamber for which a score greater than or equal to 8/10 was obtained.

### Preparation of Polyamide Powder

The powder preparation processes described below were repeated until an amount of powder sufficient to determine the working window was obtained.

### Example 1 (Comparative): Preparation of PA 12 Powder

This comparative example is similar to example 4 from document EP 1571173.

Introduced into the reactor, maintained under nitrogen, are 2800 ml of solvent (paraffinic hydrocarbon cut with a boiling range between 145° C. and 160° C.), followed successively by 899 g of dry lauryllactam, 4.95 g of EBS and 0.36 g of finely divided and dehydrated silica. After having started the stirring at 300 rpm, the mixture is gradually heated up to 110° C. and then 290 ml of solvent are distilled off under vacuum in order to azeotropically entrain any trace of water which might be present.

After returning to atmospheric pressure, the anionic catalyst, 1.79 g of sodium hydride at 60 wt % purity in oil, are then rapidly introduced under nitrogen and the stirring is increased to 400 rpm, under nitrogen at 110° C. for 30 minutes. Next, the temperature is brought back to 100.5° C. and, using a small metering pump, the stearyl isocyanate activator is continuously injected into the reaction medium, according to the following program:
3.6 g of stearyl isocyanate over 60 minutes, then
5.9 g of stearyl isocyanate over 132 minutes.

At the same time, the temperature is maintained at 100.5° C. for the first 60 minutes and is then raised to 120° C. in 30 minutes and maintained at 120° C. for 2 hours after the introduction of the stearyl isocyanate has ended.

The polymerization is then terminated, the reaction medium is cooled to 80° C. and then the powder is separated by settling and dried.

The PA 12 powder particles obtained have a volume mean diameter of 55 μm, an inherent viscosity of 1.48 (g/100 g)⁻¹, a melting temperature of 183° C. and a crystallization temperature of 135° C.

The working window was evaluated as indicated above. It is 168° C., the model construction being possible only at this temperature.

### Example 2 (According to the Invention): Preparation of PA 12 Powder

Introduced into the reactor, maintained under nitrogen, are 2800 ml of solvent (paraffinic hydrocarbon cut with a boiling range between 145° C. and 160° C.), followed successively by 919 g of lauryllactam (lactame 12), 15.0 g of EBS and 3.2 g of silica (SIPERNAT 320DS). After having started the stirring at 300 rpm, the mixture is gradually heated up to 105° C. and then 360 ml of solvent are distilled off under vacuum in order to azeotropically entrain any trace of water which might be present.

After returning to atmospheric pressure, the anionic catalyst, 2.4 g of sodium hydride at 60 wt % purity in oil, are then rapidly introduced under nitrogen and the stirring is increased to 550 rpm, under nitrogen at 105° C. for 30 minutes.

A small metering pump is used to continuously inject, into the reaction medium, the chosen activator, namely stearyl isocyanate (27.3 g in 119.7 g of solvent) according to the following program:
12 g/h of stearyl isocyanate solution over 180 minutes, then
50 g/h of stearyl isocyanate solution over 133 minutes.

At the same time, the temperature is maintained at 105° C. for 313 minutes during the injection, then after the introduction of the isocyanate has ended, this the reaction medium is heated to 150° C. in 30 minutes and maintained at this temperature for 12 hours.

At the end of polymerization, the polyamide powder is in dispersion in the synthesis solvent. The reaction medium is cooled to 80° C. in order to be able to empty the reactor: after solid/liquid separation, the polyamide powder is placed in an oven at 75° C. in order to dry it of the solvent.

The PA 12 powder particles obtained have a volume mean diameter of 38 μm, an inherent viscosity of 1.32 (g/100 g)⁻¹, a melting temperature of 184° C. associated with a melting enthalpy of 112 J/g, and a crystallization temperature of 146° C.

The working window was evaluated as indicated above. It is from 166° C. to 172° C.

### Example 3 (According to the Invention): Preparation of PA 12/6 Powder

Introduced into the reactor, maintained under nitrogen, are 2800 ml of solvent (paraffinic hydrocarbon cut with a boiling range between 145° C. and 160° C.), followed successively by 919 g of lauryllactam (lactame 12), 4.6 g of caprolactam (lactam 6), 14.0 g of EBS and 4.2 g of Orgasol® 2001 UD Nat 1 (PA 12 powder). After having started the stirring at 300 rpm, the mixture is gradually heated up to 105° C. and then 360 ml of solvent are distilled off under vacuum in order to azeotropically entrain any trace of water which might be present.

After returning to atmospheric pressure, the anionic catalyst, 3.9 g of sodium hydride at 60 wt % purity in oil, is rapidly introduced under nitrogen and the stirring is increased to 550 rpm, under nitrogen at 105° C. for 30 minutes.

A small metering pump is used to continuously inject, into the reaction medium, the chosen activator, namely stearyl isocyanate (25.3 g in 185.1 g of solvent) according to the following program:
12 g/h of stearyl isocyanate solution over 180 minutes, then
50 g/h of stearyl isocyanate solution over 210 minutes.

At the same time, the temperature is maintained at 105° C. for 390 minutes during the injection and is then raised to 150° C. in 30 minutes and maintained at this temperature for 12 hours after the introduction of the isocyanate has ended.

At the end of polymerization, the polyamide powder is in dispersion in the synthesis solvent. The reaction medium is cooled to 80° C. in order to be able to empty the reactor: after solid/liquid separation, the polyamide powder is placed in an oven at 75° C. in order to dry it of the solvent.

The PA 12/6 powder particles obtained have a volume mean diameter of 39 μm, an inherent viscosity of 1.34 (g/100 g)⁻¹, a melting temperature of 183° C. associated with a melting enthalpy of 109 J/g, and a crystallization temperature of 145° C.

The working window was evaluated as indicated above. It is from 164° C. to 172° C.

Example 4 (Comparative): Preparation of PA 12 Powder with Subsequent Heat Treatment

The particles of Orgasol® 2002 ES 4 Nat 3 PA 12 powder have a volume mean diameter of 41 μm, an inherent viscosity of 1.02 (g/100 g)⁻¹, a melting temperature of 177° C. associated with a melting enthalpy of 112 J/g, and a crystallization temperature of 150° C.

The working window was evaluated as indicated above. The powder has no working window.

A heat treatment of 88 h at 167° C. was carried out on this PA 12 powder in a stirred reactor under a stream of nitrogen, as described in document WO 2013/090174.

The powder particles after heat treatment have a volume mean diameter of 41 μm, an inherent viscosity of 1.02 (g/100 g)⁻¹, a melting temperature of 182° C. (with a pronounced shoulder at 180° C. on the DSC curve) associated with a melting enthalpy of 118 J/g, and a crystallization temperature of 150° C.

The working window was evaluated as indicated above. It is 168° C., the model construction being possible only at this temperature.

### Example 5 (According to the Invention): Preparation of PA 12/6 Powder

Introduced into the reactor, maintained under nitrogen, are 2800 ml of solvent (paraffinic hydrocarbon cut with a boiling range between 145° C. and 160° C.), followed successively by 919 g of lauryllactam (lactame 12), 4.6 g of caprolactam (lactam 6), 14.0 g of EBS and 3.0 g of Orgasol® 2001 UD Nat 1 (PA 12 powder). After having started the stirring at 300 rpm, the mixture is gradually heated up to 105° C. and then 360 ml of solvent are distilled off under vacuum in order to azeotropically entrain any trace of water which might be present.

After returning to atmospheric pressure, the anionic catalyst, 3.9 g of sodium hydride at 60 wt % purity in oil, is rapidly introduced under nitrogen and the stirring is increased to 550 rpm, under nitrogen at 105° C. for 30 minutes.

A small metering pump is used to continuously inject, into the reaction medium, the chosen activator, namely stearyl isocyanate (25.3 g in 185.1 g of solvent) according to the following program:
50 g/h of stearyl isocyanate solution over 253 minutes.

At the same time, the temperature is maintained at 105° C. for 253 minutes during the injection and is then raised to 150° C. in 30 minutes and maintained at this temperature for 6 hours after the introduction of the isocyanate has ended.

At the end of polymerization, the polyamide powder is in dispersion in the synthesis solvent. The reaction medium is cooled to 80° C. in order to be able to empty the reactor: after solid/liquid separation, the polyamide powder is placed in an oven at 75° C. in order to dry it of the solvent.

The PA 12/6 powder particles obtained have a volume mean diameter of 42 μm, an inherent viscosity of 1.16 (g/100 g)⁻¹, a melting temperature of 182° C. associated with a melting enthalpy of 122 J/g, and a crystallization temperature of 149° C.

The working window was evaluated as indicated above. It is from 168° C. to 172° C.

### Results

It is found that the powders according to the invention have a wide working temperature window for 3D printing, of at least 4° C., when the curing step has been carried out for a period of 6 h at 150° C. and of at least 6° C. when it has been carried out for a period of 12 h at 150° C. In addition, it is noted that the PA 12 powder according to the invention of example 2 has a very enlarged working temperature window compared with the PA 12 powder of comparative example 1, in which the curing step is carried out for a period of 2 h at 120° C.

Moreover, when a heat treatment is carried out on the powder a posteriori (comparative example 4), the enlargement of the working window is not achieved even if the Tm−Tc difference has increased. According to the inherent viscosity results before and after heat treatment, no change in the molar mass is observed. These results suggest that it is necessary for the curing step to take place on the compounds under polymerization conditions in order to obtain an enlargement of the working window.

1. A process for manufacturing a polyamide powder by anionic polymerization in a solvent, comprising the following steps:
a) forming a reaction medium comprising:
introducing at least one lactam monomer into said solvent;
introducing at least one catalyst into said solvent; and
introducing at least one activator into said solvent at a given temperature;
b) polymerizing the lactam monomer to polyamide in the reaction medium;
c) precipitating the polyamide in powder form in the reaction medium; and
d) heating, after step a), the reaction medium to a temperature above the temperature for introducing the at least one activator and that is from 140° C. to 200° C.

2. The process as claimed in claim 1, wherein the heating of step d) is carried out for a time greater than or equal to 2 h.

3. The process as claimed in claim 1, wherein step a) further comprises introducing at least one filler into the solvent.

4. The process as claimed in claim 1, wherein step a) further comprises introducing at least one amide into the solvent.

5. The process as claimed in claim 1, wherein the at least one lactam monomer is chosen from the group consisting of 2-pyrrolidone, caprolactam, 2-azacyclononanone, lauryllactam and mixtures thereof.

6. The process as claimed in claim 1 , wherein the at least one catalyst is chosen from the group consisting of sodium, potassium, alkali metal hydrides and hydroxides, alkali metal alkoxides, and mixtures thereof.

7. The process as claimed in claim 1, wherein the at least one activator is chosen from the group consisting of lactam-N-carboxyanilides, (mono)isocyanates, polyisocyanates, carbodiimides, cyanamides, acyllactams and acylcarbamates, triazines, ureas, N-substituted imides, esters, phosphorus trichloride and mixtures thereof.

8. The process as claimed in claim 1, in which the solvent is a paraffinic hydrocarbon cut having a boiling temperature range between 120° C. and 170° C.

9. The process as claimed in claim 1, wherein the heating temperature in step d) is from 140° C. to 170° C.

10. The process as claimed in claim 1, wherein the temperature for introducing the at least one activator is from 50° C. to 150° C.

11. The process as claimed in claim 1, further comprising a step of introducing into the solvent one or more additives chosen from the group consisting of pigments, dyes, carbon black, carbon nanotubes, antioxidants, UV stabilizers and plasticizers.

12. A polyamide powder obtained by a manufacturing process as claimed in claim 1.

13. A method comprising using a powder as claimed in claim 12 for the construction of a three-dimensional article.

14. A method comprising using a powder as claimed in claim 12, for the manufacture of a composite, a substrate coating, a transfer paper, a liquid or solid ink composition, a liquid or solid paint, a structural adhesive, a cosmetic composition or a pharmaceutical composition.

15. A process for manufacturing a three-dimensional article, comprising the following steps:
manufacturing a powder by a process as claimed in claim 1;
depositing said powder; and
sintering the powder.
